(19) United States
(12) Patent Application Publication
(10) Pub. No.: US 2012/0073790 A1
(43) Pub. Date: Mar. 29, 2012

(54) WASTEWATER HEAT RECOVERY DEVICE AND METHOD THEREOF

(75) Inventors: Sung Kyoon Moon, Seoul (KR); Ho Hyun Jung, Incheon (KR); Jong Sun Lee, Gyeonggi-do (KR)

(73) Assignee: Sung Kyoon Moon, Seoul (KR)

(21) Appl. No.: 13/322,364

(22) PCT Filed: Jun. 27, 2009
(86) PCT No.: PCT/KR09/03490

§ 371 Date: Nov. 23, 2011

(30) Foreign Application Priority Data
May 27, 2009 (KR) 10-2009-0046415

(51) Int. Cl. F28F 19/00; C02F 1/00

(52) U.S. Cl. 165/119; 210/181

(57) ABSTRACT

The present invention relates to a wastewater heat recovery device and a method thereof which prevent blockage phenomenon by effectively removing sediment and fine foreign material included in the wastewater. For this purpose, the wastewater heat recovery device comprises: a settling filter unit for settling the sediment contained in the wastewater according to the sedimentation treatment of the wastewater supplied; a heat exchange unit for receiving the wastewater, in which sediment has been removed by passing through the settling filter unit, simultaneously with receiving cold cleans water, and then achieving heat exchange between the wastewater and the cold clean water so as to make hot clean water of the cold clean water; and a filtering unit, which is installed between the settling filter unit and the heat exchange unit, for primarily filtering fine foreign material contained in the wastewater passed through the settling filter unit and then secondly filtering fine foreign material contained in the wastewater passed through the heat exchange unit. In this meantime, the wastewater heat recovery method according to the resent invention, comprises: a settling treatment step of settling the sediment contained in the wastewater according to the sedimentation treatment of the wastewater supplied; a step of primarily filtering fine foreign material contained in the settling treated wastewater; a step of heat-exchanging the primarily filtered wastewater with the cold clean water to make hot clean water of the cold clean water; and a step of secondly filtering the fine foreign material contained in the heat exchanged wastewater.

### FIELD

The present invention relates to a wastewater heat recovery device and method thereof, more particularly to a wastewater heat recovery device and method thereof, capable of preventing blockage phenomenon by primarily removing sediment included in the wastewater using a settling filter unit and secondly removing a fine foreign material included in the wastewater using a filtering unit, and maximizing a filtering efficiency of the filtering unit by switching circulation directions of the wastewater and clean water in a predetermined period.

### BACKGROUND

Generally, wastewater heat recovery equipment in which heat of the wastewater is recovered and reused is constructed of a wastewater collection tank in which a hot wastewater is stored a cold clean water tank in which cold clean water is stored, wherein heat is recovered from the hot wastewater and the cold clean water is changed into a hot clean water to be gathered in a hot clean water tank.

That is, the hot wastewater is pumped and pressure transferred to a heat exchanger and the cold clean water is pumped and pressure transferred to a heat exchanger and the hot wastewater and the cold clean water reversely flow in the heat exchanger, whereby heat of the hot wastewater transfers to the cold clean water so that the cold clean water becomes a hot clean water.

At this time, there may be occurred a phenomenon in which a sediment and a fine foreign material included in the hot wastewater blockades wastewater paths of the heat exchanger and pipe, the wastewater heat recovery equipment includes a filter for filtering the sediment and fine foreign material.

However, there is a problem in that the filter may be frequently blockaded by the sediment and fine foreign material included in the hot wastewater. Accordingly, a means to effectively process a sediment and fine foreign material included in the hot wastewater is needed.
the present invention provides a wastewater heat recovery device and method thereof, capable of preventing blockage phenomenon by primarily removing sediment included in the wastewater using a settling filter unit and secondly removing a fine foreign material included in the wastewater using a filtering unit, and maximizing a filtering efficiency of the filtering unit by switching circulation directions of the wastewater and clean water in a predetermined period.

### SUMMARY

According to an aspect of the present invention, there is provided a wastewater heat recovery device, including a settling filter unit for settling the sediment contained in the wastewater according to the sedimentation treatment of the wastewater supplied; a heat exchange unit for receiving the wastewater, in which sediment has been removed by passing through the settling filter unit, simultaneously with receiving cold cleans water, and then achieving heat exchange between the wastewater and the cold clean water so as to make hot clean water of the cold clean water; and a filtering unit, which is installed between the settling filter unit and the heat exchange unit, for primarily filtering fine foreign material contained in the wastewater passed through the settling filter unit and then secondly filtering fine foreign material contained in the wastewater passed through the heat exchange unit.

Preferably, the settling filter unit may include a wastewater settling tank formed in a cone shape whose lower sectional area is less than upper sectional area; a wastewater supply inlet that is included at an upper one side of the wastewater settling tank and with which the wastewater is supplied; a wastewater discharge outlet that extends upward communicating with an top surface of the wastewater settling tank and discharges the wastewater whose sediment has been removed; a sediment collection tank that is integrally formed in the lower portion of the wastewater settling tank and in which the sediment is settled and collected; and a sediment discharge outlet that extends downward communicating with the bottom surface of the sediment collection tank and includes a sediment discharge tank to discharges the sediment periodically.

Preferably, the heat exchanger may include a wastewater supply space that includes a wastewater feeding entrance to be provided with the wastewater that passes through the settling filter unit; a wastewater discharge space that communicates with the wastewater supply space through a plurality of pipes, and includes a wastewater discharge opening to discharge the wastewater supplied to the wastewater supply space; and a heat exchange space that includes a cold water feeding entrance and a hot water discharge opening with which the cold clean water flows on the surface of the plurality of the pipes and the cold clean water changes into the hot clean water after being transferred heat.

Preferably, the heat exchanger may include a wastewater backflow module that is connected to the wastewater feeding entrance and the wastewater discharge opening and mounted therebetween in order that the wastewater fed to the wastewater feeding entrance and discharged through the wastewater discharge opening.

Preferably, the device may further include a wastewater discharge valve to discharge the wastewater flowing from the wastewater discharge opening, wherein the filtering unit stops a filtering and at the same time the wastewater discharge valve is opened in case that the wastewater reversely flows using the wastewater backflow module.

Preferably, the filtering unit may include first and second filters that are installed apart each other; a first path switching module that alternatively switches any one of the first and second filters and transfers the wastewater that passed through the setting filter unit thereto; and a second path switching module that alternatively switches any one of the first and second filters and transfers the wastewater that passes through the heat exchange thereto.

Preferably, in case that the first path switching module transfers the wastewater that passed through the setting filter unit to the first filter, the second path switching module may transfer the wastewater that passes through the heat exchange to the second filter.

Preferably, the device may further include a wastewater pressure sensor for sensing a supply pressure of the wastewater supplied to the settling filter unit, wherein in case that a pressure value sensed in the wastewater pressure sensor is higher than a reference region, the first path switching module switches to transfer the wastewater that passed through the settling filter unit to the second filter, and the second path switching module switches to transfer the wastewater that passed through the heat exchanger to the first filter.

Preferably, in the case that the first path switching module transfer the wastewater that passed the settling filter unit to the second filter, the second path switching module may transfer the wastewater that passes the heat exchanger to the first filter.

Preferably, the device may further include a wastewater pressure sensor for sensing a supply pressure of the wastewater that is supplied to the settling filter unit, wherein in the case that a pressure sensed in the wastewater pressure sensor is higher than a reference region, the first path switching module switches to transfer the wastewater that passed through the settling filter unit to the first filter, and the second path switching module switches to transfer the wastewater that passed through the heat exchanger to the second filter.

Preferably, an alarm may be generated in the case that the pressure value sensed in the wastewater pressure sensor is lower than a reference region.

Preferably, the device may further include a cold clean water temperature sensor for sensing temperature of the cold clean water supplied to the heat exchanger; a hot clean water temperature for sensing temperature of the hot clean water that was heat exchanged in the heat exchanger; a first wastewater temperature sensor for sensing temperature of the wastewater supplied to the heat exchanger; and a second wastewater temperature sensor for sensing temperature of the wastewater whose heat was exchanged in the heat temperature.

According to another aspect of the present invention, there is provided a wastewater heat recovery method, including a settling treatment step of settling the sediment contained in the wastewater according to the sedimentation treatment of the wastewater supplied; a step of primarily filtering fine foreign material contained in the settling treated wastewater; a step of heat-exchanging the primarily filtered wastewater with the cold clean water to make hot clean water of the cold clean water; and a step of secondly filtering the fine foreign material contained in the heat exchanged wastewater.

### EFFECTS

According to the present invention, there is an advantage of preventing blockage phenomenon by primarily removing sediment included in the wastewater using a settling filter unit and secondly removing a fine foreign material included in the wastewater using a filtering unit.

According to the present invention, there is another advantage of maximizing a filtering efficiency of the filtering unit by switching circulation directions of the wastewater and clean water in a predetermined period.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a first operation state of a wastewater heat recover device according to an embodiment of the present invention.

FIG. 2 is a block diagram illustrating a second operation state of a wastewater heat recovery device according to an embodiment of the present invention.

FIG. 3 is a block diagram illustrating a third operation state of a wastewater heat recovery device according to an embodiment of the present invention.

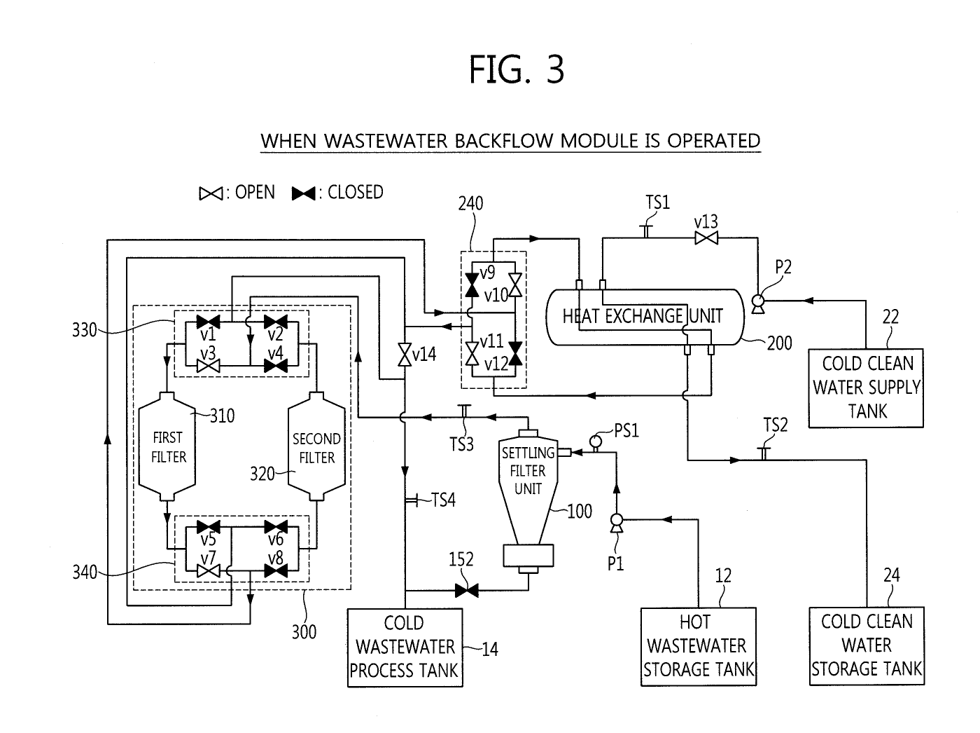

FIG. 4 is a schematic constructional diagram illustrating a settling filter unit of a wastewater heat recovery device according to an embodiment of the present invention.

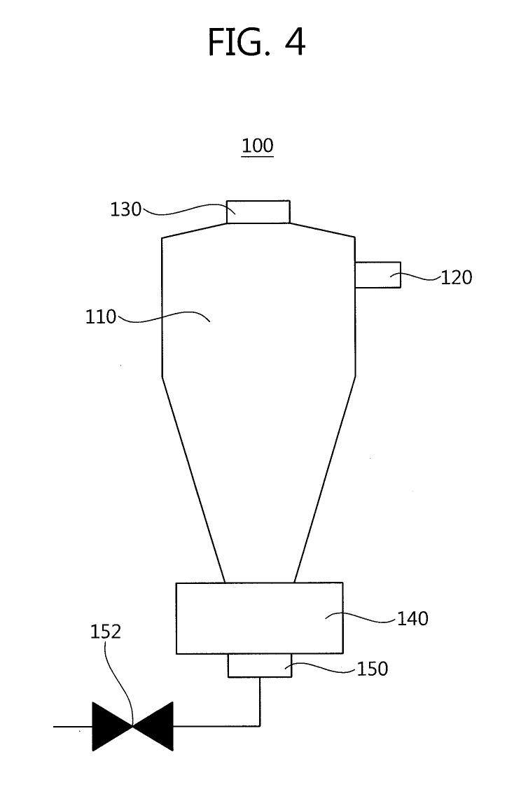

FIG. 5 is a schematic construction diagram illustrating a wastewater heat recovery device according to an embodiment of the present invention.

FIG. 6 is a schematic constructional diagram illustrating a filter of a wastewater heat recovery device according to an embodiment of the present invention.

### DETAILED DESCRIPTION OF THE PREFERRED EMBODIMENTS

The present invention will now be described more fully with reference to the accompanying drawings, in which exemplary embodiments of the invention are shown. Hereinafter, a detail description is given to make those skilled in the art understand and reproduce the invention with ease through the embodiments of the present invention.

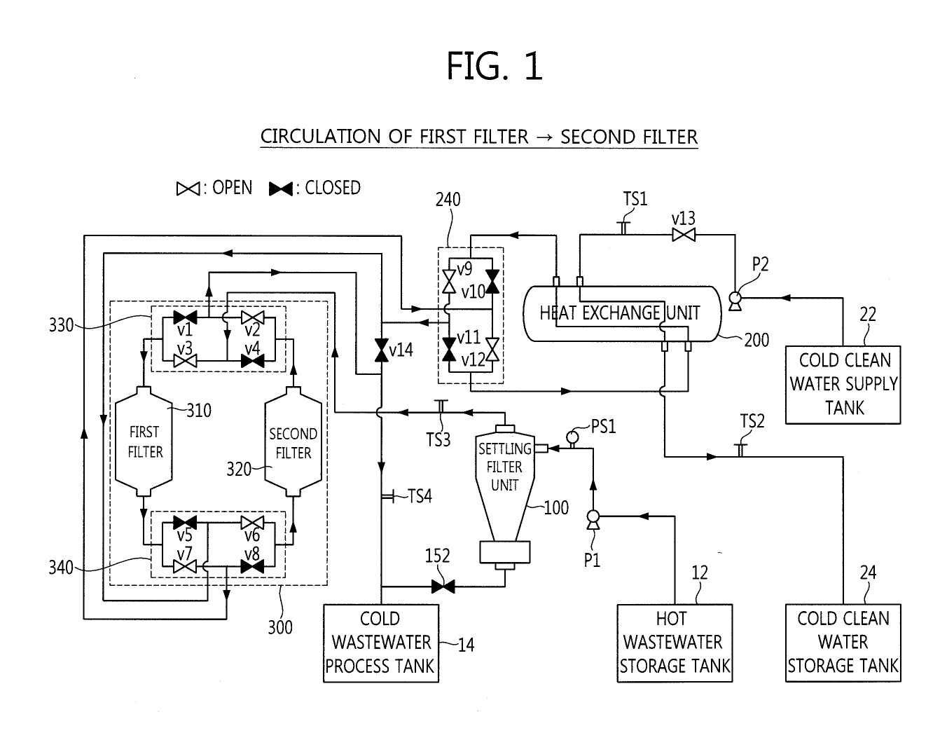

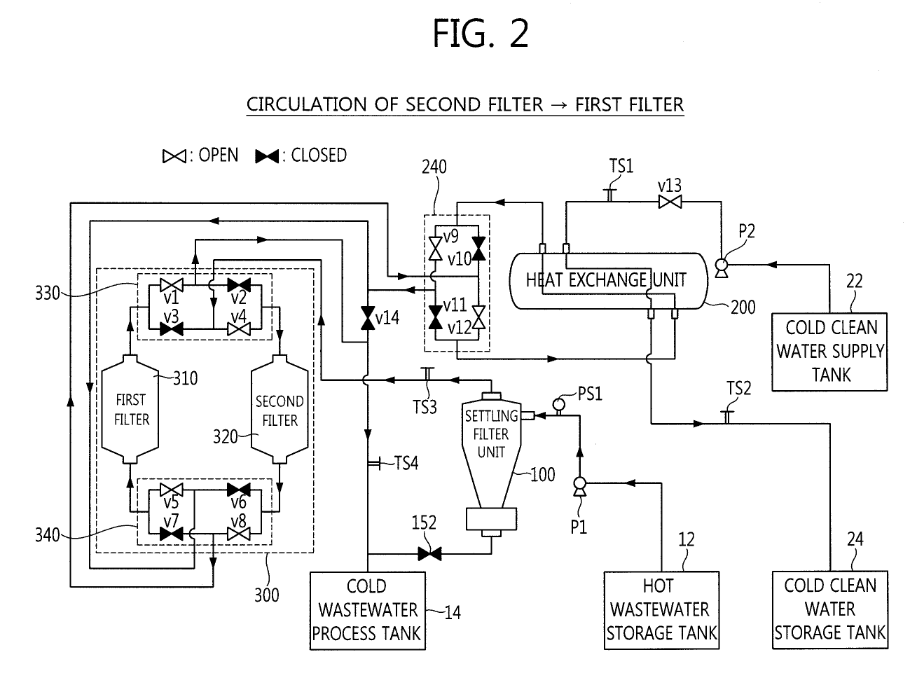

A wastewater heat recovery device according to an embodiment of the present invention is generally constructed of a settling filter unit 100, a heat exchange unit 200 and a filtering unit 300 as illustrated in FIGS. 1 and 2.

The settling filter unit 100 serves to settle a sediment contained in the wastewater according to the sedimentation treatment of the wastewater supplied.

The heat exchange unit serves to receive the wastewater, in which sediment has been removed by passing through the settling filter unit 100, simultaneously with receiving cold cleans water, and then achieving heat exchange between the wastewater and the cold clean water so as to make hot clean water of the cold clean water

The filtering unit 300 is installed between the settling filter unit and the heat exchange unit and serves to primarily filter fine foreign material contained in the wastewater passed through the settling filter unit and then secondly filter fine foreign material contained in the wastewater passed through the heat exchange unit.

First, the settling filter unit 100 will be described.

The settling filter unit 100 servers to settle a sediment contained in the wastewater according to the sedimentation treatment of the wastewater supplied, which is generally constructed of a wastewater settling tank 110, a wastewater supply inlet 120, a wastewater discharge outlet 130, a sediment collection tank 140 and a sediment discharge outlet 150.

The wastewater settling tank 110 is formed in a cone shape whose lower sectional area is less than upper sectional area, which has a space formed to receive the wastewater therein. Preferably, the wastewater settling tank 110 has an upper portion formed in a cylinder shape and a lower portion formed in a cone shape.

The wastewater supply inlet 120 is included at an upper one side of the wastewater settling tank and is supplied with the wastewater. The wastewater supplied to the wastewater settling tank 110 from a hot wastewater storage tank is circulated by a whirl generated in the tank 110 and at this time, a sediment included in the wastewater is gathered downward by dead load.

The wastewater discharge outlet 130 extends upward communicating with an top surface of the wastewater settling tank 110 and discharges the wastewater whose sediment has been removed. It discharges the wastewater whose sediment is removed according to a circulation caused by a whirl in the wastewater settling tank 110.

The sediment collection tank 140 is integrally formed in the lower portion of the wastewater settling tank 110. As the sediment included in the wastewater is gathered downward, the sediment is collected in the sediment collection tank 140. At this time, it is preferable that the sediment collection tank 140 has a structure that it has a sectional area greater than that of the lower portion of the wastewater settling tank 110, and so it is prevented that the sediment is floated as the wastewater forms a whirl.

The sediment discharge outlet 150 communicates with a bottom surface of the sediment collection tank 140 and extends downward, and has a sediment discharge valve 152 to periodically discharge the sediment gathered in the sediment collection tank 140. When the amount of the sediment gathered in the sediment collection tank 140 is more than a predetermined one, the sediment discharge valve 152 is opened and the sediment gathered in the sediment collection tank 140 is discharged to the cold wastewater discharge outlet 150.

According to the settling filter unit 100 constructed as described above, the wastewater is supplied into the wastewater settling tank 110 through the wastewater supply inlet 120, the sediment included in the wastewater supplied is settled, collected in the sediment collection tank 140 and discharged through the sediment discharge outlet 150 and the wastewater whose sediment is removed is discharged through the wastewater discharge outlet 130.

Next, the heat exchange unit 200 will be described.

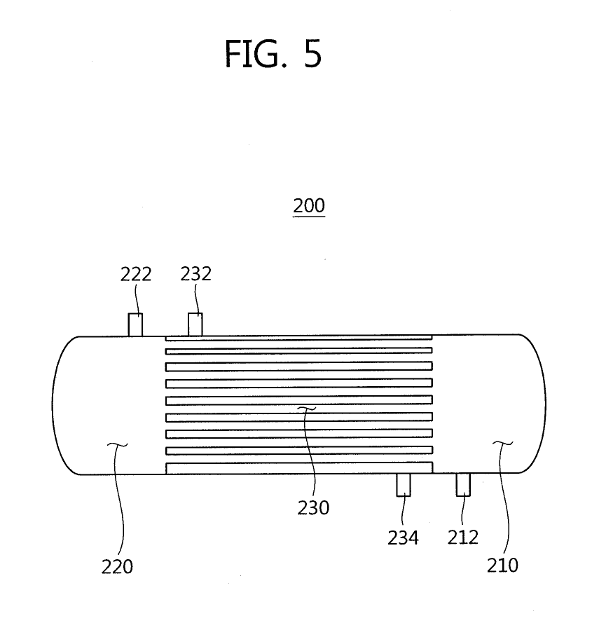

The heat exchange unit 200 receives the wastewater that passed through the settling filter unit 100 so as to remove its sediment and cold clean water at the same time so that it changes the cold clean water into hot clean water by performing a heat exchange between the wastewater and the cold clean water. It is constructed of a wastewater supply space 210, a wastewater discharge space 220 and a heat exchange space 230 as illustrated in FIG. 5.

The wastewater supply space 210 includes a wastewater feeding entrance 212 to be provided with the wastewater that passes through the settling filter unit 100. In detail, the wastewater whose sediment was removed in the settling filter unit 100 is supplied to a wastewater feeding entrance 212 and gathered in the wastewater supply space 210.

The wastewater discharge space 220 communicates with the wastewater supply space 210 through a plurality of pipes and includes a wastewater discharge opening 222 to discharge the wastewater supplied to the wastewater supply space 210. In detail, the wastewater gathered in the wastewater supply space 210 is supplied to the wastewater discharge space 220 through the plurality of pipes and gathered.

The heat exchange space 230 includes a cold clean water feeding entrance 232 and a hot clean water discharge opening 234, wherein the cold clean water flows on the surface of the plurality of the pipes and the cold clean water changes into the hot clean water. In detail, it is formed of a space that encloses the plurality of pipes at the same time and makes them closed, including the cold clean water feeding entrance 232 at one side of the closed space and a hot clean water discharge outlet 234 at the other side of the closed space.

According to the heat exchange unit 200 constructed as described above, the wastewater is gathered in the wastewater supply space 210 through the wastewater feeding entrance 212, gathered in the wastewater discharge space 220 through the plurality of pipes and discharged to the wastewater discharge opening 222. At the same time, the cold clean water flows on the surface of the plurality of pipes through the cold clean water feeding entrance 232 so that the cold clean water discharges through the hot clean water discharge opening 234 and at this time, heat of the wastewater flowing through the plurality of pipes is transferred to the cold clean water flowing on the surface of the plurality of pipes so that the cold clean water is raised in temperature and becomes a hot clean water.

Meanwhile, the heat exchange unit 200 is constructed including a wastewater backflow module 240 that is connected to the wastewater feeding entrance 212 and the wastewater discharge opening 222 and mounted therebetween in order to make the wastewater fed into the wastewater feeding entrance 212 and discharged to the wastewater discharge opening 222 flown in the reverse direction.

The wastewater backflow module 240 serves to remove a foreign material that is formed in a textile and remained in the heat exchange unit 200. It makes the wastewater flown in the reverse direction in order to remove the foreign material of a textile form that are simultaneously hung on the plurality of pipes, the pipes connecting the wastewater supply space 210 and the wastewater discharge space 220.

That is, since the foreign material formed in a textile is hung and remained at an end (wastewater supply space 210 side) of the plurality of the pipes in “U” shape when the wastewater supplied to the wastewater feeding entrance 212 flows in a forward direction, from the wastewater supply space 210 to the wastewater discharge space 220, the wastewater is flown in the reverse direction, from the wastewater discharge space 220 to the wastewater supply space 210, so that the foreign material of a textile form hung in “U” shape can be removed.

At this time, the wastewater backflow module 240 is constructed of a plurality of automatic control valves that is connected on the wastewater feeding entrance 212 and the wastewater discharge opening 222 and installed thereon. That is, a ninth valve V9, a tenth valve (V10), an eleventh valve (V11) and a twelfth valve (V12) are constructed on a path of the wastewater feeding entrance 212 and the wastewater discharge opening 222 so that the wastewater flowing in the heat exchange unit 200 can be controlled to flow in the forward direction or reverse direction.

For example, when flowing in the forward direction, it is controlled that the ninth valve (V9) is in an open state, the tenth valve (V10) is in a closed state, the eleventh valve (V11) is in a closed state, and the twelfth valve (V12) is in an open state, the wastewater supplied is directed to the wastewater feeding entrance 212 through the twelfth valve (V12), directed to the wastewater discharge opening 222 and then discharged through the ninth valve (V9). Further, when flowing in the reverse direction, it is controlled that the ninth valve (V9) is in a closed state, the tenth valve (V10) is in an open state, the eleventh valve (V11) is in an open state, and the twelfth valve (V12) is in a closed state, the wastewater supplied is directed to the wastewater discharge opening 222 through the tenth valve (V10), directed to the wastewater feeding entrance 212, and then discharged through the eleventh valve (V11).

Meanwhile, it is preferable that when the wastewater flows in the reverse direction, there is included a wastewater discharge valve (V14) to discharge the wastewater flowing through the wastewater discharge opening 222, and when the wastewater flows in the reverse direction by the wastewater backflow module 240, the filtering unit 300 stops the filtering and at the same time the wastewater discharge valve (V14) is opened. That is, since the wastewater flowing from the wastewater discharge opening 222 includes a foreign material of a textile form, the filtering in the filtering unit 300 is stopped in order that the wastewater is not transferred to the filtering unit 300, and the wastewater discharge valve (V14) is opened so that the wastewater including the foreign material of a textile form is directly supplied to the cold wastewater process tank 14 and processed.

Next, the filtering unit 300 will be described.

The filtering unit 300 is installed between the settling filter unit 100 and the heat exchange unit 200, and primarily filters fine foreign material that is included in the wastewater that passed through the settling filter unit 100 and secondly filters the fine foreign material included in the wastewater that passed through the heat exchange unit 200. The filtering unit 300 is constructed including a first filter 310 and a second filter 320, a first path switching module 330 and a second path switching module 340 as illustrated in FIG. 1.

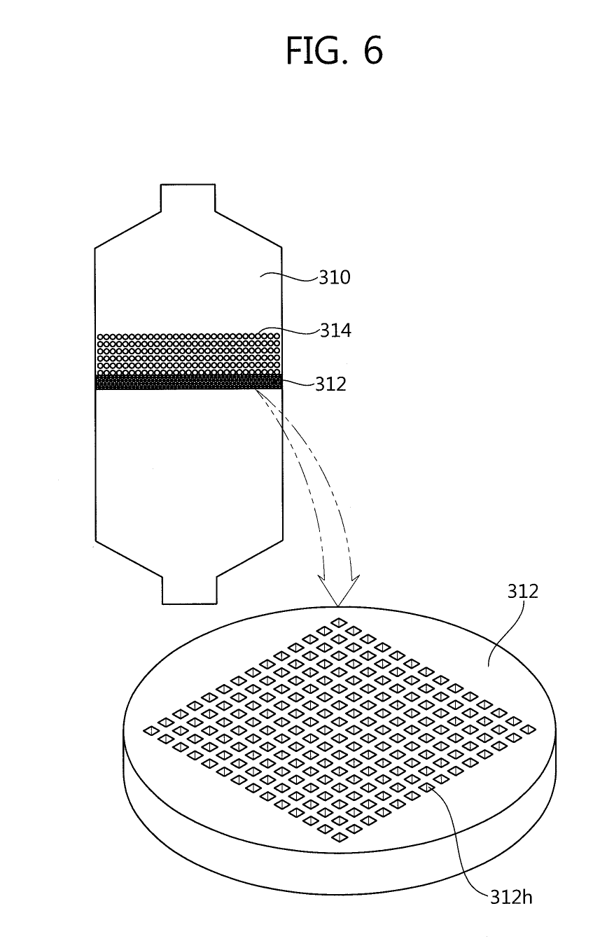

The first and second filters 310 and 320 are installed apart each other. And, as illustrated in FIG. 6, the wastewater is supplied to or discharged from the first and second filters 310 and 320 through the upper portion and lower portion. A filter panel 312 having a number of square holes 312h is included in the center of the first and second filters 310 and 320, and large amount of steelie is filled in an upper space of the filter panel 312.

The first and second filters 310 and 320 are constructed in the same structure, they are described with reference to the first filter 310 illustrated in FIG. 6 as follows. When the wastewater is supplied through the upper portion of the first filter 310, the fine foreign material included in the wastewater is filtered during it passes through the large amount of steelie and then flows downward the filter through the square holes 312h of the filter channel 312. When wastewater is supplied from the lower portion of the first filter 310, as the wastewater flows among the steelie through the square holes 312h of the filter channel 312, the fine foreign material remaining among the steelie is floated and flows to the upper portion of the filter together with the wastewater.

The direction switching of the wastewater in the first and second filters 310 and 320, that is, from the upper portion to the lower portion and from lower portion to the upper portion, can be performed by the first and second path switching module 330 and 340.

The first path switching module 330 alternatively switches the wastewater that passed through the settling filter unit 100 to the first filter 310 or the second filter 320, and the second path switching module 340 alternatively switches the wastewater that passed through the heat exchange unit 200 to the first filter 310 or the second filter 320 and transfers the wastewater to it.

At this time, when the first path switching module 330 transfers the wastewater that passed through the settling filter unit 100 to the first filter 310, the second path switching module 340 transfers the wastewater that passed through the heat exchange unit 200 to the second filter 320, and when the first path switching module 330 transfers the wastewater that passed through the settling filter unit 100 to the second filter 320, the second path switching module 340 transfers the wastewater that passed through the heat exchange unit 200 to the first filter 310.

Meanwhile, a path switching operation of the first and second path switching modules 330 and 340 may be performed in predetermined period or by a sensing of the wastewater pressure sensor PS1 that senses a supply pressure of the wastewater supplied to the settling filter unit 100.

For example, when the first path switching module 330 transfers the wastewater that passed through the settling filter unit 100 to the filter unit 310 and the second path switching module 340 transfers the wastewater that passed through the heat exchange unit 200 to the second filter 320, in the case that the pressure value sensed by the wastewater pressure sensor PS1 is higher than a reference region, the first path switching module 330 switches the wastewater that passed through the settling filter unit 100 to the second filter 320 and the second path switching module 340 switches the wastewater that passed through the heat exchange unit 200 to the first filter 310.

Further, when the first path switching module 330 transfers the wastewater that passed through the settling filter unit 100 to the second filter 320, and the second path switching module 340 transfers the wastewater that passed through the heat exchange unit 200 to the first filter 310, in the case that a pressure value sensed by the wastewater pressure sensor PS1 is higher than a reference region, the first path switching module 330 switches the wastewater that passed through the settling filter unit 100 to the first filter 310 and the second path switching module 340 switches the wastewater that passed through the heat exchange unit 200 to the second filter 320.

At this time, the pressure value sensed by the wastewater pressure sensor PS1 can be raised by the fine foreign material filtered in the first filter 310 and second filter 320 of the filtering unit 300, and for example, when the fine foreign material is accumulated in the first filtering unit 300 more than a predetermined amount, the pressure value sensed by the wastewater pressure sensor PS1 becomes increased.

Meanwhile, when the pressure value sensed by the wastewater pressure sensor PS1 is lower than the reference region, it means an emergency situation such as wastewater leakage, so that an alarm is generated to make an operator known it.

The wastewater heat recovery device constructed including the settling filter unit 100, the heat exchange unit 200 and the filtering unit 300 may include a cold clean water temperature sensor TS1 for sensing temperature of the cold clean water supplied to the heat exchange unit 200, a hot clean water temperature sensor TS2 for sensing temperature of the hot clean water whose heat was exchanged in the heat exchange unit 200, a first wastewater temperature sensor TS3 for sensing temperature of the wastewater supplied to the heat exchange 200, and a second wastewater temperature sensor TS4 for sensing temperature of the wastewater whose heat was exchanged in the heat exchange unit 200.

Calorie obtained when the cold clean water is exchanged into the hot clean water can be known by comparing the temperature of the cold clean water temperature sensor TS1 and that of the hot clean water temperature sensor TS4, or the temperature of the first wastewater temperature TS3 and that of the second wastewater temperature sensor TS4.

Finally, an operation of the wastewater heat treatment device constructed as described above will be described as follows.

<Settling Treatment>

As illustrated in FIG. 1, the wastewater supplied from the hot wastewater storage tank 12 is fed to the wastewater feeding entrance 212 of the settling filter unit 100, and the wastewater fed to the settling filter unit 100 is whirled so that sediment contained in the wastewater settles to be gathered in the sediment collection tank 140.

At this time, the sediment gathered in the sediment collection tank 140 is periodically discharged to a sediment discharge outlet 150 by opening the sediment discharge valve 152.

<First Filtering and Second Filtering>

The wastewater whose sediment is removed in the settling fitter unit 100 is supplied to the heat exchange unit 200 through the first or second filter 310 or 320 using the first or second path switching module 330 or 340.

That is, as illustrated in FIG. 1, when the wastewater is circulated in the order of the settling filter unit 100→the first filter 310→the heat exchange unit 200→the second filter 320, the first valve V1 is in a closed state, the second valve V2 is in an open state, the third valve V3 is in an open state, the fourth valve V4 is in a closed state, the fifth valve V5 is in a closed state, the sixth valve V6 is in an open state, the seventh valve V7 is in an open state, the eighth valve V8 is in a closed state, the ninth valve V9 is in an open state, the tenth valve V10 is in a closed state, the eleventh valve V11 is in a closed state, and the twelfth valve V12 is in an open state. Further, as the wastewater flows downward from the upper portion of the first filter 310 through the third valve V3 of the first path switching module 330, the fine foreign material included in the wastewater is filtered and the wastewater whose fine foreign material was removed is supplied to the wastewater backflow module 240 through the seventh valve V7 of the second path switching module 340, and the wastewater supplied to the wastewater backflow module 240 is supplied to the wastewater feeding entrance 212 of the heat exchange unit 200 through the twelfth valve V12 of the wastewater backflow module 240.

As described above, when the wastewater is circulated in the order of the settling filter unit 100→the first filter 310→the heat exchange unit 200→the second filter 320, while the wastewater is filtered in the first filter 310, the fine foreign material is floated in the second filter 320 together with the wastewater so that they are transferred to the cold wastewater process tank 14.

Further, as illustrated in FIG. 2, when the wastewater is circulated in the order of the settling filter unit 100→the second filter 320→the heat exchange unit 200→the first filter 310, the first valve V1 is in an open state, the second valve V2 is in a closed state, the third valve V3 is in a closed state, the fourth valve V4 is in an open state, the fifth valve V5 is in an open state, the sixth valve V6 is in a closed state, the seventh valve V7 is in a closed state, the eighth valve V8 is in an open state, the ninth valve V9 is in an open state, the tenth valve V10 is in a closed state, the eleventh valve V11 is in a closed state, and the twelfth valve V12 is in an open state. Further, as the wastewater flows downward from the upper portion of the second filter 320 through the fourth valve V4 of the first path switching module 330, the fine foreign material included in the wastewater is filtered, and the wastewater whose fine foreign material is filtered is supplied to the wastewater backflow module 240 through the eighth valve V8 of the second path switching module 340. Further, the wastewater supplied to the waste backflow module 240 is supplied to the wastewater feeding entrance 212 of the heat exchange unit 200 through the twelfth valve V12 of the wastewater backflow module 240.

As described above, the wastewater is circulated in the order of the settling filter unit 100→the second filter 320→the heat exchange unit 200→the first filter 310, while the wastewater is filtered in the second filter 320, the fine foreign material is floated in the first filter 310 together with the wastewater so that they are transferred to the cold wastewater process tank 14.

<Heat Exchange>.

When the wastewater is circulated in the order of the settling filter unit 100→the first filter 310→the heat exchange unit 200→the second filter 320, the wastewater filtered in the first filter 212 is fed to the wastewater feeding entrance 121 of the heat exchange 200, and the cold clean water supplied from the cold clean water supply tank 22 is fed to the cold clean water feeding entrance 232 of the heat exchange unit 200. Accordingly, the heat of the wastewater is transferred to the cold clean water so that the cold clean water becomes the hot clean water.

When the wastewater is circulated in the order of the settling filter unit 100→the first filter 310→the heat exchange unit 200→the second filter 320, the wastewater filtered in the second filter 320 is also fed to the wastewater feeding entrance 212 of the heat exchange 200, and the cold clean water supplied from the cold clean water supply tank 22 is fed to the cold clean water feeding entrance 232 of the heat exchange unit 200 and accordingly, the heat of the wastewater is transferred to the cold clean water so that the cold clean water becomes the hot clean water. The hot clean water is gathered in the hot clean storage tank 24.

P1 that is not described herein denotes a pump used to pump the hot wastewater, P2 denotes a pump to pump the cold clean water, and V13 is an automatic valve to turn on/off the supplication of the cold clean water supplied to the heat exchange 200 from the cold clean water supply tank 22.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A wastewater heat recovery device, comprising:
a settling filter unit for settling the sediment contained in the wastewater according to the sedimentation treatment of the wastewater supplied;
a heat exchange unit for receiving the wastewater, in which sediment has been removed by passing through the settling filter unit, simultaneously with receiving cold cleans water, and then achieving heat exchange between the wastewater and the cold clean water so as to make hot clean water of the cold clean water; and
a filtering unit, which is installed between the settling filter unit and the heat exchange unit, for primarily filtering fine foreign material contained in the wastewater passed through the settling filter unit and then secondly filtering fine foreign material contained in the wastewater passed through the heat exchange unit.

2. The device according to claim 1, wherein the settling filter unit includes:
a wastewater settling tank formed in a cone shape whose lower sectional area is less than upper sectional area;
a wastewater supply inlet that is included at an upper one side of the wastewater settling tank and with which the wastewater is supplied;
a wastewater discharge outlet that extends upward communicating with an top surface of the wastewater settling tank and discharges the wastewater whose sediment has been removed;
a sediment collection tank that is integrally formed in the lower portion of the wastewater settling tank and in which the sediment is settled and collected; and
a sediment discharge outlet that extends downward communicating with the bottom surface of the sediment collection tank and includes a sediment discharge tank to discharges the sediment periodically.

3. The device according to claim 1, wherein the heat exchanger includes:
a wastewater supply space that includes a wastewater feeding entrance to be provided with the wastewater that passes through the settling filter unit;
a wastewater discharge space that communicates with the wastewater supply space through a plurality of pipes, and includes a wastewater discharge opening to discharge the wastewater supplied to the wastewater supply space; and
a heat exchange space that includes a cold water feeding entrance and a hot water discharge opening with which the cold clean water flows on the surface of the plurality of the pipes and the cold clean water changes into the hot clean water after being transferred heat.

4. The device according to claim 3, wherein the heat exchanger includes a wastewater backflow module that is connected to the wastewater feeding entrance and the wastewater discharge opening and mounted therebetween in order that the wastewater fed to the wastewater feeding entrance and discharged through the wastewater discharge opening.

5. The device according to claim 4, further including a wastewater discharge valve to discharge the wastewater flowing from the wastewater discharge opening, wherein the filtering unit stops a filtering and at the same time the wastewater discharge valve is opened in case that the wastewater reversely flows using the wastewater backflow module.

6. The device according to claim 1, wherein the filtering unit includes first and second filters that are installed apart each other; a first path switching module that alternatively switches any one of the first and second filters and transfers the wastewater that passed through the setting filter unit thereto; and a second path switching module that alternatively switches any one of the first and second filters and transfers the wastewater that passes through the heat exchange thereto.

7. The device according to claim 6, wherein in case that the first path switching module transfers the wastewater that passed through the setting filter unit to the first filter, the second path switching module transfers the wastewater that passes through the heat exchange to the second filter.

8. The device according to claim 7, further including a wastewater pressure sensor for sensing a supply pressure of the wastewater supplied to the settling filter unit, wherein in case that a pressure value sensed in the wastewater pressure sensor is higher than a reference region, the first path switching module switches to transfer the wastewater that passed through the settling filter unit to the second filter, and the second path switching module switches to transfer the wastewater that passed through the heat exchanger to the first filter.

9. The device according to claim 6, wherein in the case that the first path switching module transfer the wastewater that passed the settling filter unit to the second filter, the second path switching module transfers the wastewater that passes the heat exchanger to the first filter.

10. The device according to claim 9, further including a wastewater pressure sensor for sensing a supply pressure of the wastewater that is supplied to the settling filter unit, wherein in the case that a pressure sensed in the wastewater pressure sensor is higher than a reference region, the first path switching module switches to transfer the wastewater that passed through the settling filter unit to the first filter, and the second path switching module switches to transfer the wastewater that passed through the heat exchanger to the second filter.

11. The device according to claim 8 or 10, wherein an alarm is generated in the case that the pressure value sensed in the wastewater pressure sensor is lower than a reference region.

12. The device according to claim 1, further comprising:
a cold clean water temperature sensor for sensing temperature of the cold clean water supplied to the heat exchanger;
a hot clean water temperature for sensing temperature of the hot clean water that was heat exchanged in the heat exchanger;
a first wastewater temperature sensor for sensing temperature of the wastewater supplied to the heat exchanger; and
a second wastewater temperature sensor for sensing temperature of the wastewater whose heat was exchanged in the heat temperature.

13. A wastewater heat recovery method, comprising:
a settling treatment step of settling the sediment contained in the wastewater according to the sedimentation treatment of the wastewater supplied;
a step of primarily filtering fine foreign material contained in the settling treated wastewater;
a step of heat-exchanging the primarily filtered wastewater with the cold clean water to make hot clean water of the cold clean water; and a step of secondly filtering the fine foreign material contained in the heat exchanged wastewater.
